(19) United States
(12) Patent Application Publication
(10) Pub. No.: US 2009/0072458 A1
(43) Pub. Date: Mar. 19, 2009

(54) SELF-CONSTRAINED DYNAMIC DAMPER

(75) Inventor: Troy P. Rodecker, Berlin Heights, OH (US)

Correspondence Address: HARNESS, DICKEY & PIERCE, P.L.C., P.O. BOX 828, BLOOMFIELD HILLS, MI, 48303, US

(73) Assignee: The Pullman Company, Milan, OH (US)

(21) Appl. No.: 11/856,085

(22) Filed: Sep. 17, 2007

(51) Int. Cl. F16F 7/00

(52) U.S. Cl. 267/141

(57) ABSTRACT

A vibration damper assembly includes a mass, a retaining member and an elastomeric member bonded to the mass and the retaining member. The retaining member includes a constraining device that prohibits the mass from being disassembled from the retaining member should the elastomeric member or the bond deteriorate.

### FIELD

The present disclosure relates generally to vibration damper assemblies. More particularly, the present disclosure relates to a vibration damper assembly which utilizes an existing component of the vibration damper assembly to constrain the damping mass.

### BACKGROUND

The statements in this section merely provide background information related to the present disclosure and may not constitute prior art.

Damping devices and in particular dynamic damper assemblies are currently used in many applications including applications in the automotive industry for damping out unwanted vibrations imparted to the vehicle. These unwanted vibrations can be initiated by the engine of the vehicle, the tires of the vehicle, the road surface the vehicle is traveling over, the exhaust system of the vehicle or any other vehicle component.

Various types of damper assemblies have been developed to dampen out these unwanted vibrations. The construction of these damper assemblies are typically a large mass and an elastomeric spring element. The elastomeric spring element is attached to the large mass via a bond through either a mold bonding or a post molding bonding operation. As a failsafe for the deterioration of the bond or the deterioration of the elastomer which may result in the large mass becoming loose, a secondary attachment for the mass to a structural component of the vehicle must be provided. This secondary attachment can be a cord, a welded brace or any other means which prohibits the large mass from falling off of the vehicle.

### SUMMARY

The present disclosure provides a vibration damper assembly that incorporates the secondary attachment into an existing component of the vibration damper assembly. The incorporation of the secondary attachment into an existing component allows for the increase in the amount of travel for the large mass, the elimination of the added components for the secondary attachment and their associated costs and the simplification for the design and assembly to the vehicle

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a side cross-sectional view of a vibration damper assembly in accordance with the present disclosure.

FIG. 2 is a top plan view of the vibration damper assembly illustrated in FIG. 1.

FIG. 3 is a side cross-sectional view of a vibration damper assembly in accordance with another embodiment of the present disclosures.

FIG. 4 is a top plan view of the vibration damper assembly illustrated in FIG. 3.

### DETAILED DESCRIPTION

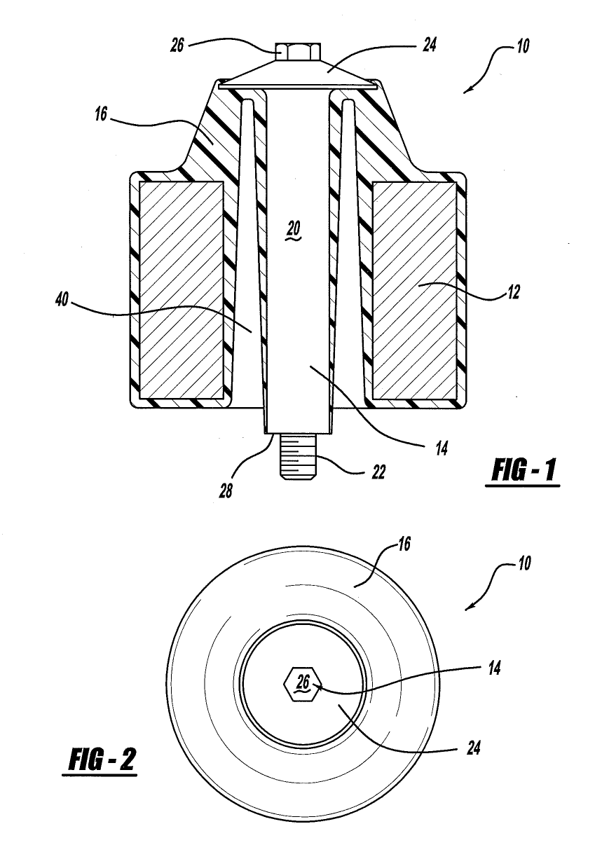

The following description is merely exemplary in nature and is not intended to limit the present disclosure, application, or uses. There is illustrated in FIGS. 1 and 2 a vibration damper assembly 10 in accordance with the present disclosure. Vibration damper assembly 10 includes a mass 12, a retaining member or retaining means 14 and an elastomeric member 16.

Mass 12 is an annular component of a specified size having a predetermined height, an inner hole having a predetermined inside dimension, a predetermined outside dimension and a predetermined material. Mass 12 is designed to vibrate at a specified frequency in order to attenuate the vibration of the component to which it is attached.

Retaining means 14 is a bolt having an elongated shaft 20, a threaded end 22, a flange 24 and a hex cap 26. Elongated shaft 20 extends through the center or inside dimension of mass 12 and a specified clearance is defined between the outside surface of elongated shaft 20 and the inside surface of mass 12. Elongated shaft 20 extends beyond the end of mass 12 and elongated shaft 20 defines a mounting shoulder 28 which engages the component to which vibration damper assembly 10 is attached. By extending beyond the end of mass 12 and by providing the specified clearance between elongated shaft 20 and mass 12, mass 12 is allowed to freely vibrate with respect to elongated shaft 20.

Threaded end 22 extends from one end of elongated shaft 20 to engage a threaded hole or a threaded member used to secure vibration damper assembly 10 to the specified component. While vibration damper assembly 10 is being illustrated with a male threaded end 22, it is within the scope of the present disclosure to utilize a female thread, a rivet, or any other means for securing vibration damper assembly 10 to the specified component.

Flange 24 is attached to the end of elongated shaft 20 opposite to threaded end 22. The outside dimension of flange 24 is designed to be larger than the inside dimension of mass 12. Thus, it is not possible for mass 12 to move over or past flange 24. This provides constraining means which is the constraining feature of the present disclosure as described below. Vibration damper assembly 10 is illustrated as having an annular frusto-conical shaped flange 24. The present disclosure is not limited to the annular frusto-conical shape of flange 24. Flange 24 can be any shape including cylindrical, star shaped or any other shape as long as mass 12 is constrained by flange 24.

Hex cap 26 extends from flange 24 to provide for the assembly of vibration damper assembly 10 to the specified component. Hex cap 26 can be integral with flange 24 or it can be separate from flange 24. Hex cap 26 is integral or fixed to elongated shaft 20 through flange 24 or by being directly secured or integral with elongated shaft 20. While vibration damper assembly 10 is illustrated having hex cap 26, the present disclosure is not limited to hex cap 26 and any shape, whether it be male or female, can be utilized as means for securing vibration damper assembly 10 to the specified component.

Elastomeric member 16 is bonded to both mass 12 and retaining means 14. Elastomeric member 16 can be bonded to mass 12 and/or retaining means 14 during the molding operation for elastomeric member 16 or elastomeric member 16 can be bonded to mass 12 and/or retaining means 14 during a post molding operation. Elastomeric member 16 is designed to fully encase mass 12. The encasement of mass 12 by elastomeric member 16 protects mass 12 from the outside environment thus eliminating the need to paint or otherwise protect vibration damper assembly 10 from the outside elements and the encasement also avoids any type of metal to metal contact between mass 12 and retaining means 14. Elastomeric member 16 is designed to bond with and cover the entire length of elongated shaft 20 and to bond with and cover the surface of flange 24 opposite to hex cap 26. This provides a bonded assembly which does not include any loose parts.

Once assembled to the specific component, vibration damper assembly 10 vibrates at the predetermined frequency to attenuate the vibrations of the specified component. The material, shape and size of mass 12 and the material, shape and size of elastomeric member 16 determine the vibrational characteristics for vibration damper assembly 10. A gap 40 exists between the portion of elastomeric member 16 covering the inside dimension of mass 12 and the portion of elastomeric member 16 covering elongated shaft 20 of retaining means 14 to provide for the free movement of mass 12 with respect to retaining means 14. Mass 12 is constrained by flange 24 such that flange 24 prevents mass 12 from disassembly from retaining means 14 should deterioration of elastomeric member 16 or the deterioration of the bonding of elastomeric member 16 occur.

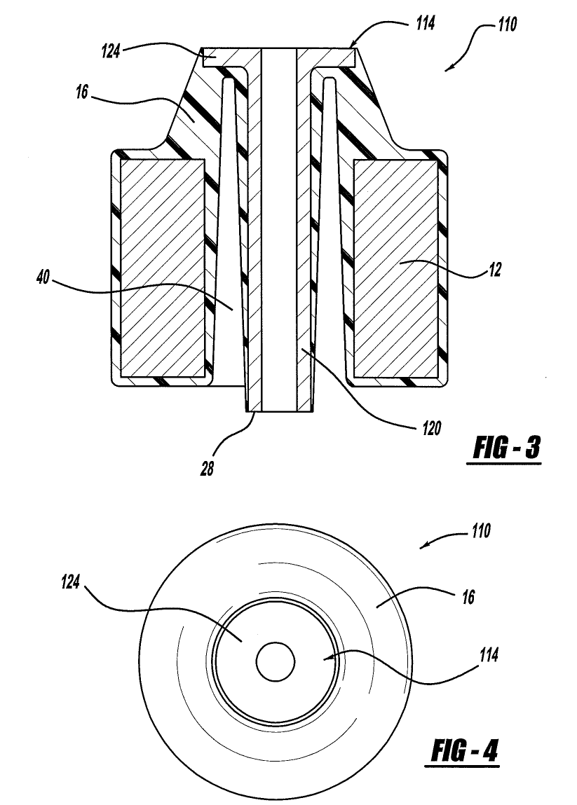

Referring now to FIGS. 3 and 4, a vibration damper assembly 110 in accordance with another embodiment of the present disclosure is illustrated. Vibration damper assembly 110 includes mass 12, a retention member or retaining means 114 and elastomeric member 16. Thus, vibration damper assembly 110 is the same as vibration damper assembly 10 except that retaining means 14 has been replaced with retaining means 114.

Mass 12 is the same as described above and thus, the detailed description will not be repeated.

Retaining means 114 is a fastener having an inner tube 120 and a ferrule 124. Inner tube 120 extends through the center or inside dimension of mass 12 and a specified clearance is defined between the outside surface of inner tube 120 and the inside dimension of mass 12. Inner tube 120 extends beyond the end of mass 12 and inner tube 120 defines mounting shoulder 28 which engages the component to which vibration damper assembly 110 is attached. By extending beyond the end of mass 12 and by providing the specified clearance between inner tube 120 and mass 12, mass 12 is allowed to freely vibrate with respect to inner tube 120.

Ferrule 124 is attached to the end of inner tube 120 opposite to mounting shoulder 28. The outside dimension of ferrule 124 is designed to be larger than the inside dimension of mass 12. Thus, it is not possible for mass 12 to move over or past ferrule 124. This provides the constraining feature of the present disclosure as described below. Vibration damper assembly 110 is illustrated as having an annular disc shaped ferrule 124. The present disclosure is not limited to the disc shape of ferrule 124. Ferrule 124 can be any shape including frusto-conical, star shaped or any other shape as long as mass 12 is constrained by ferrule 124.

Vibration damper assembly 110 is secured to the specified component using a bolt or other retaining means which extend through the center of inner tube 120.

Elastomeric member 16 is bonded to both mass 12 and retaining means 114. Elastomeric member 16 can be bonded to mass 12 and/or retaining means 114 during the molding operation for elastomeric member 16 or elastomeric member 16 can be bonded to mass 12 and/or retaining means 114 during a post molding operation. Elastomeric member 16 is designed to fully encase mass 12. The encasement of mass 12 by elastomeric member 16 protects mass 12 from the outside environment thus eliminating the need to paint or otherwise protect vibration damper assembly 10 from the outside elements and the encasement also avoids any type of metal to metal contact between mass 12 and retaining means 114. Elastomeric member 16 is designed to bond with and cover the entire length of inner tube 120 and to bond with and cover one side surface of ferrule 124. This provides a bonded assembly which does not include any loose parts.

Once assembled to the specific component, vibration damper assembly 10 vibrates at the predetermined frequency to attenuate the vibrations of the specified component. The material, shape and size of mass 12 and the material, shape and size of elastomeric member 16 determine the vibrational characteristics for vibration damper assembly 10. Gap 40 exists between the portion of elastomeric member 16 covering the inside diameter of mass 12 and the portion of elastomeric member 16 covering inner tube 120 of retaining means 14 to provide for the free movement of mass 12 with respect to retaining means 114. Mass 12 is constrained by ferrule 124 such that ferrule 124 prevents mass 12 from disassembly from retaining means 114 should deterioration of elastomeric member 16 or the deterioration of the bonding of elastomeric member 16 occur.

What is claimed is:

1. A vibration damper assembly comprising:
a mass;
a retaining member assembled to said mass;
an elastomeric member disposed between said mass and said retaining member; and
means for constraining said mass from disassembly from said retaining member.

2. The vibration damper assembly according to claim 1 wherein said mass defines an inner hole and said retaining member extends through said inner hole.

3. The vibration damper assembly according to claim 2 wherein said retaining member includes a flange, said flange being larger than said inner hole to define said constraining means.

4. The vibration damper assembly according to claim 2 wherein said retaining member includes a ferrule, said ferrule being larger than said inner hole to define said constraining means.

5. The vibration damper assembly according to claim 2 wherein said mass is fully encased by said elastomeric member.

6. The vibration damper assembly according to claim 1 wherein said mass is fully encased by said elastomeric member.

7. The vibration damper assembly according to claim 1 wherein:
said mass defines an inner hole; and
said retaining member defines an elongated shaft extending through said inner hole and a flange extending from said elongated shaft, said flange being larger than said inner hole to define said constraining means.

8. The vibration damper assembly according to claim 7 wherein said mass is fully encased by said elastomeric member.

9. The vibration damper assembly according to claim 7 wherein said elastomeric member is bonded to said mass, said elongated shaft and said flange.

10. The vibration damper assembly according to claim 9 wherein said mass is fully encased by said elastomeric member.

11. The vibration damper assembly according to claim 1 wherein;
said mass defines an inner hole; and
said retaining member defines an inner tube extending through said inner hole and a ferrule extending from said inner tube, said ferrule being larger than said inner hole to define said constraining means.

12. The vibration damper assembly according to claim 11 wherein said mass is fully encased by said elastomeric member.

13. The vibration damper assembly according to claim 11 wherein said elastomeric member is bonded to said mass, said inner tube and said ferrule.

14. The vibration damper assembly according to claim 13 wherein said mass is fully encased by said elastomeric member.
